(19) United States
(12) Patent Application Publication
(10) Pub. No.: US 2010/0218489 A1
(43) Pub. Date: Sep. 2, 2010

(54) METHOD FOR CHECKING THE COMPLETENESS OF A REGENERATION OF A PARTICLE FILETER IN THE EXHAUST GAS OF AN INTERNAL COMBUSTION ENGINE

(75) Inventors: Horst Harndorf, Schauenburg (DE); Christian Fuchs, Stuttgart (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/377,359

(22) PCT Filed: Nov. 8, 2007
(86) PCT No.: PCT/EP2007/062080

§ 371 Date: Feb. 12, 2009

(30) Foreign Application Priority Data
Nov. 23, 2006 (DE) 102006055237.7

(51) Int. Cl. F01N 9/00; F01N 3/023; G01M 15/10

(52) U.S. Cl. 60/311; 73/23.33

(57) ABSTRACT

Proposed is a method for assessing the completeness of a regeneration of a particle filter which is traversed by the exhaust gas of an internal combustion engine, wherein a pressure difference which is generated across the particle filter when a flow passes through the particle filter is measured and evaluated for the assessment. The method is characterized in that a time derivative of the measured pressure difference is formed and the assessment of the completeness of the regeneration takes place as a function of the time derivative.

### TECHNICAL FIELD

The invention concerns a procedure according to the generic term of claim 1, the application of such a procedure, as well as a control unit according to the generic term of claim 6.

### BACKGROUND

Such a procedure, such an application and such a control unit are already known from the commercial use at motor vehicles with diesel engines. Particle filters present effective measures for reducing the emissions of soot at combustion engines, in particular diesel engines. The soot particles that are contained in the exhaust gas deposit in the particle filter when passing through the particle filter. With an increasing soot load of the particle filter the exhaust gas pressure increases. As a result the efficiency of the combustion engine declines. The fuel consumption increases and the motor vehicle accelerates worse. In order to limit the negative influence of the soot load, the particle filter has to be freed from time to time from the stored root particles, which is also called regeneration. The regeneration takes place by combusting the soot that is stored in the particle filter with oxygen from the exhaust gas into carbon dioxide.

The combustion is actuated by power-operated measures, which cause an increase of the exhaust gas temperature. This is achieved by interventions into the air system of the combustion engine, for example a throttling, and/or interventions into the injection process. The regeneration begins when the exhaust gas temperature exceeds the ignition temperature of the soot in the particle filter.

At a motor vehicle such a regeneration typically takes place depending on the load of the soot particle filter with air after a driving distance of approximately 300 to 800 km. the load depends on the soot raw emissions of the combustion engine and the size of the particle filter. For the detection of the load the signal of a pressure difference sensor is evaluated at the known subject matter, which detects a pressure difference, which generates at the pass through the particle filter. Under the condition of a constant exhaust gas volume flow the pressure difference increases with an increasing load of the particle filter with soot. The pressure difference that standardized to the volume flow provides a dimension for the flow resistance and therefore for the load of the particle filter with soot. The control unit calculates such a dimension depending on operating parameters of the combustion engine and controls the regeneration of the particle filter depending on the mentioned dimension.

A regeneration is for example initiated when the standardized pressure difference exceeds a first threshold. An initiated regeneration usually lasts several minutes and ends at the known subject matter when the quotient of the pressure difference and the exhaust gas volume flow falls below a lower threshold.

### SUMMARY

For a correct operation of the exhaust gas purification system with the particle filer it is important that the regeneration takes place at the right point of time and is implemented as complete as possible. Repeatedly occurring incomplete regenerations are disadvantageous for the following reasons: the good efficiency of modern combustion engines, in particular modern diesel engines, is accompanied with correspondingly low exhaust gas temperatures and particle filter temperatures. Each regeneration causes a temperature variation in stress due to the high exhaust gas temperature that is necessary for the soot combustion, which lets the particle filter age. A high frequency of initiated regenerations causes therefore a faster ageing and therefore an undesired shortening of the operational life span of the particle filter. Besides each regeneration requires a certain fuel expenditure for heating the exhaust gas system. Incomplete regenerations increase the fuel consumption and further, because they cause an increased exhaust gas pressure in a timely average, which has a disadvantageous effect on the efficiency of the combustion engine.

Surprisingly it showed that the known evaluation of the quotient of pressure difference and exhaust gas mass flow at the operation of a diesel motor with a mostly constant exhaust gas mass flow, thus especially at an operation with an exhaust gas mass flow, which is mostly constant during and after the regeneration, is not sufficient to detect an incomplete regeneration of the particle filter reliably.

Regenerations controlled by the known procedure are especially terminated often too early at these combustion engines. That causes that the particle filter is correspondingly fast loaded again, so that a new regeneration attempt is initiated. Summed up, this results in an inadequate high frequency of regeneration attempts, which causes the mentioned disadvantages of a hastily ageing and an increased fuel consumption.

It is also disadvantageous that familiar control functions for controlling the completeness of the regeneration are based on an evaluation of a frequency of initiated regeneration attempts. Therefore a comparably long time lapses at the state of the art, in which the combustion engine is operated with an averagely too high exhaust gas pressure and therefore with an increased fuel consumption, until determining a not sufficient regeneration, which causes a high value of the frequency.

Based on this the task of the invention is the representation of an improved detection of an incomplete regeneration of a particle filter, whereby the representation concerns procedure aspects as well as application aspects and device aspects.

This task is each solved by the characteristics of the independent claims. It has shown that the evaluation of the time derivative of the detected pressure difference according to the invention allows more reliable statements about the completeness of a regeneration than the familiar evaluation of the pressure difference. A further advantage is that the invention allows an evaluation of the regeneration success already directly after an individual regeneration of the particle filter. Therefore even system errors can be detected faster than at the known procedure, which evaluates a frequency of regeneration attempts and therefore has to wait for several regeneration attempts. By a faster detection of incomplete regenerations it can be intervened faster into the control of the regeneration. The increases of the fuel consumption and the age based wearout of the particle filter that are associated with the too frequently initiated regenerations can therefore be prevented or at least reduced.

Further advantages arise from the dependent claims, the description and the attached figures.

It is self-evident that the previously mentioned and subsequently explained characteristics can not only be applied in the stated combination, but also in other combinations or alone, without leaving the scope of the present invention.

### BRIEF DESCRIPTION OF THE DRAWINGS

Embodiments of the invention are illustrated in the drawings and further explained in the subsequent description. It is schematically shown:

FIG. 1 is a combustion engine, which provides an exhaust gas system with a particle filter;

FIG. 2 is an embodiment of a procedure according to the invention in the form of a flow diagram;

FIG. 3 is a time course of the difference pressure over the particle filter after a complete and after an incomplete regeneration, and

FIG. 4 shows values of the time derivative of the difference pressure in an application over the regeneration success.

### DETAILED DESCRIPTION

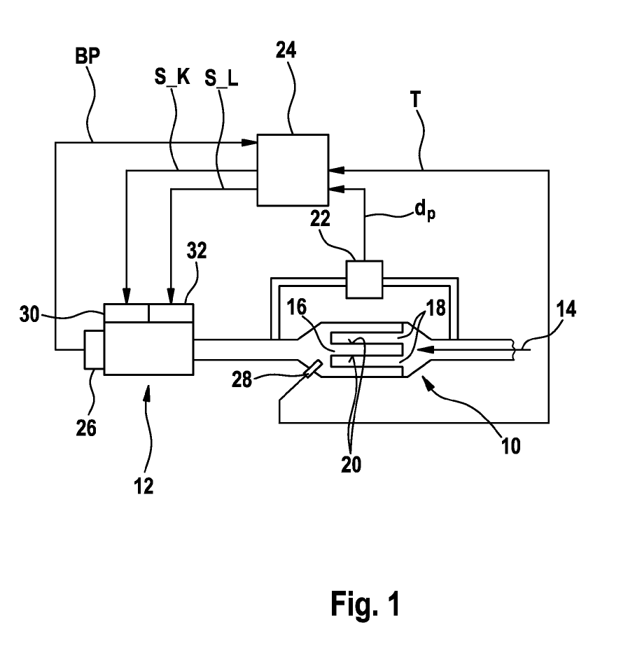

FIG. 1 shows among others a cross-section of a particle filter 10, in which exhaust gas of a combustion engine 12 flows from left to right. The particle filter 10 provides a porous filter structure 14, which is permeable for the exhaust gas, but does not let through soot particle that are contained in the exhaust gas or only a small part. The porous filter structure 14 provides in the embodiment in FIG. 1 either way left or right closed channels 16, 18, which are separated from each other by porous walls 20. In order to pass the particle filter 10, the exhaust gas has to flow through the porous walls 20. Soot particles that are in the exhaust gas deposit thereby in the pores of the walls 20, which blocks these gradually and increases the flow resistance of the particle filter 10.

The flow resistance causes a pressure drop at the through-flow of the particle filter 10, which is detected as a difference pressure dp by a difference pressure sensor 22 and transferred to a control unit 24. In the following the difference pressure as well as the pressure signal are termed with the same reference sign dp. The control unit 24 creates a dimension for the load of the particle filter 10 with soot depending on the pressure signal dp. Depending on the arrangement the pressure signal dp can also be used as a dimension for the load, since the pressure difference dp over the particle filter 10 grows monotonously with the load of the particle filter 10.

The control unit 24 is preferably a control unit, which creates correcting variables S_L and S_K for the operation of the combustion engine 12 depending on the signal dp of the difference pressure sensor 22 and signals BP, T of further sensors 26, 28. Operating parameters of the combustion engine 12, such as the engine speed, intake air mass, load pressure, driver request, combustion chamber pressure, combustion noises and so on, show in the signals BP of sensors 26, whereby this list is not meant to be final and the control unit 24 also does not have to proceed signals to all mentioned operating parameters. The sensor 28 detects a temperature T before or in the particle filter 10. In a preferred embodiment this temperature T serves as actual value for a temperature regulation, with which the particle filter temperature is kept above the ignition temperature of the soot during a regeneration of the particle filter 10. With the corrective variables S_L the control unit 24 intervenes into an air system 30 (there for example into a throttle valve or an exhaust gas recirculation valve) and with the corrective variable S_K into a fuel system 32 (there for example into an injector arrangement) of the combustion engine 12.

Besides the control unit 24 is customized, in particular programmed, to control a course of the procedure according to the invention or a course of one or several embodiments.

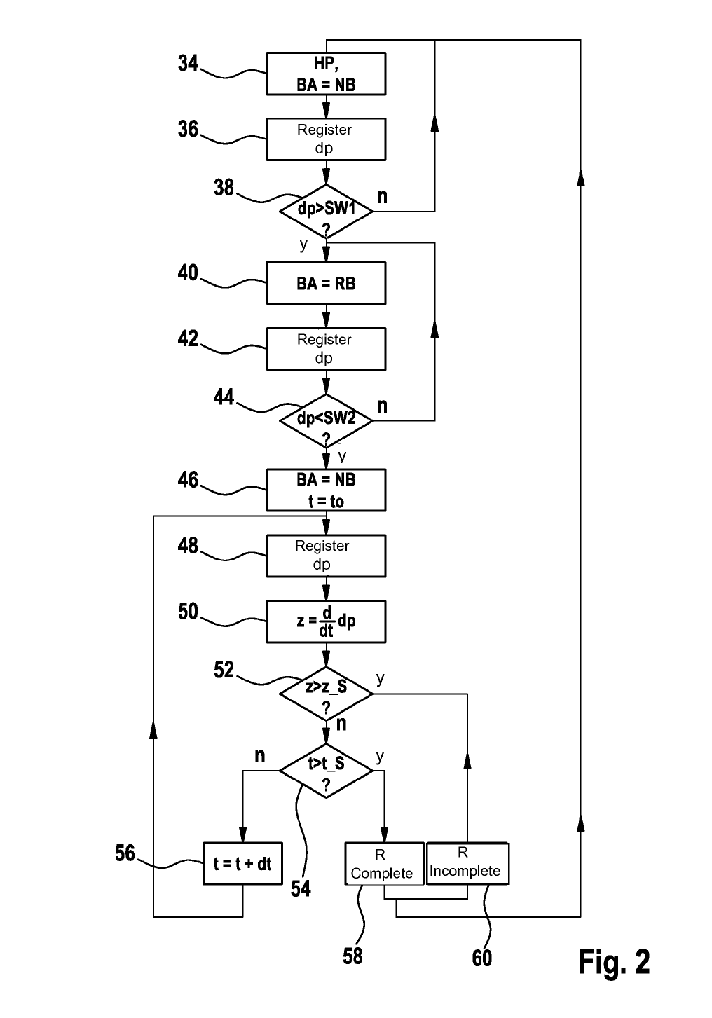

FIG. 2 shows an embodiment of the procedure according to the invention in the form of a flow diagram. Step 34 thereby represents a main program HP for controlling the combustion engine 12, which is processed in the control unit 24. In the main program of step 34 the combustion engine 12 is operated in a normal operation NB. The term normal operation serves to distinguish it from the term regeneration operation and comprises therefore all operation types BA, in which no regeneration of the particle filter 10 takes place. Therefore the selected operation type BA is the normal operation NB (BA=NB) in the main program of step 34.

For checking the load of the particle filter 10 with soot the main program from step 34 branches repeatedly into a step 36, in which the difference pressure dp is detected over the particle filter 10, as it is provides by the difference pressure sensor 22. A step 38 follows that by comparing the value of the detected pressure difference dp with a threshold value SW1. As long as dp does not exceed the threshold value SW1, the program branches back into step 34, in which the combustion engine 12 is continued to be operated in normal operation NB.

If the difference pressure dp however exceeds the threshold value SW1, step 40 follows step 38, in which the operation type BA of the combustion engine 12 is switched from or reversed to normal operation NB into a regeneration operation RB. In this regeneration operation RB the control unit 24 controls the combustion engine 12, so that the temperature of its exhaust gases is increased so high that the ignition temperature of the soot in the particle filter 10 is reached or exceeded. This takes place preferably by changing the corrective variables S_L for the air system 32 and/or S_K for the fuel system 30.

For increasing the exhaust gas temperature early, burning or accumulated after injections, a late time shift of the main injection and an inlet air throttling or an increase of the exhaust gas recirculation rate comes into question. Combinations of this measure are also possible. Alternatively or additionally also late after injections come into question, which cause a further exhaust gas temperature increase by oxidizing the fuel that is not burned anymore in the combustion chamber in an oxidation catalyzer.

In order to provide a reliable regeneration of the particle filter 10 even at disadvantageous environment conditions, the exhaust gas temperature is regulated at the regeneration in a preferred embodiment. For the regulation of the exhaust gas temperature the temperature signal of the temperature sensor 28 serves as an initial value, which is arranged before or in the particle filter 10. Alternatively or additionally to the detection of an actual temperature of the particle filter or the exhaust gas such an actual temperature can also be calculated in the control unit 24 from operating parameters of the combustion engine 12 like the sucked in air amount and injected fuel amount by an exhaust gas temperature model that is realized as a software module.

Subsequent to step 40 the difference pressure dp that is present at the regeneration operation RB over the particle filter 10 is detected in step 42 and compared in step 44 with a second threshold value SW2. The second threshold value SW2 is smaller than the first threshold value SW1. It is fallen below, if the particle filter 10 is almost completely regenerated. T the beginning of the regeneration the difference pressure dp is nevertheless not higher than the threshold value SW2, so that the request in step 44 is negated and the program branches back to step 40, in which the regeneration operation RB is continued. The regeneration operation RB is continued by a repeated pass through the loop from steps 40, 42 and 44 so long until it is determined in step 44 that the difference pressure dp falls below the second threshold value SW2 due to an advancing regeneration of the particle filter 10.

In that case the mentioned loop from steps 40, 42 and 44 is left and the program branches into step 46, in which the operation type BA of the combustion engine 12 is controlled back from the regeneration operation RB into normal operation NB. Thereby a time or count variable t of an internal timer of the control unit 24 is set to an initial value t0. Subsequently in step 48 a new detection of the difference pressure dp takes place. In step 50 the time derivative z=d/dt (dp) is created. In step 52 the time derivative z and therefore the changing speed of the difference pressure dp is compared with a threshold value z_S.

At an almost complete regeneration of the particle filter 10 the difference pressure dp increases only slowly after the regeneration. The increase is correspondingly flat and the value of the time derivative z correspondingly small, so that the threshold value z_S is not exceeded in step 52. In that case steps 54 follows, in which the time or count variable t is compared with a threshold value t_S. This will not yet be the case, so that the request is negated in step 54 and step 56 follows, in which the value of the time or count variables t is increased by an increment dt.

This is followed by a new detection of the difference pressure dp in step 48. The loop from steps 48, 50, 52, 54 and 56 is then repeatedly passed through until the value of the time or count variable t exceeds the threshold value t_S in step 54 by a repeated incrementing. The program branches then into step 58, in which the regeneration R is assessed as complete. Altogether a time derivative z that is created after the end of the regeneration is compared with a threshold z_S and the regeneration then assessed as successful, if the time derivative z is smaller than a default threshold. Subsequently the procedure returns into the main program of step 34. The time request in step 54 causes that the value z of the increase is controlled no more than for the duration of a time span t_S. the comparison with the threshold for the increase takes therefore only place within a defined time span t_S after the end of the regeneration.

If the regeneration R has not been sufficient, the difference pressure dp initially increases comparably fast in the subsequent normal operation NB. Thereby a comparably high value of the derivative z results in step 50, so that the threshold value z_S is exceeded in step 52 at a sufficiently incomplete regeneration R. the procedure branches then from step 52 into step 60, in which the regeneration R is assessed as incomplete. In contrast to the state of the art this assessment takes place right after a single regeneration.

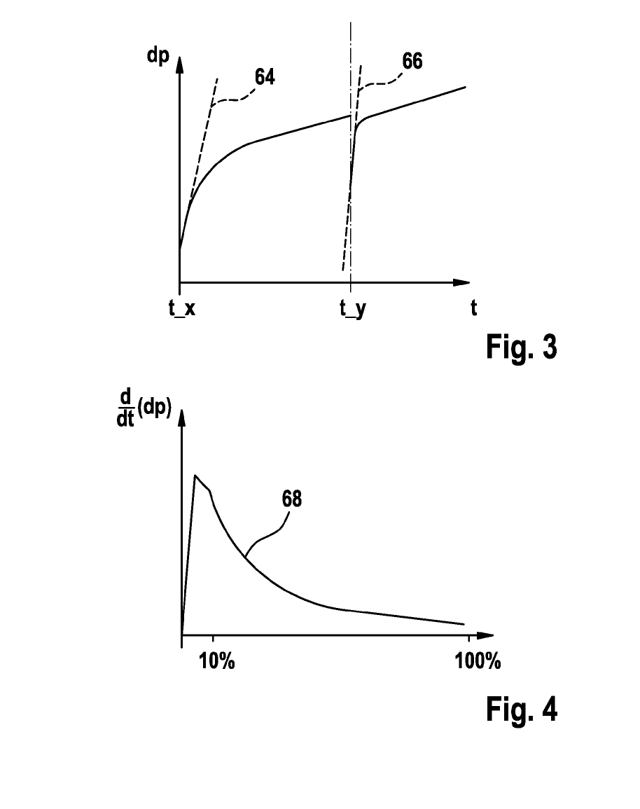

FIG. 3 shows a course of the difference pressure dp over the time t. At the point of time t_x the particle filter is completely unloaded of soot particles and is then subsequently loaded over a period of time in the dimension of hours. The tangent 64 clarifies thereby the beginning increase of the dp(t)-curve, which decreases in the further course. At the point of time t 1 the particle filter is regenerated. In contrast to the point of time t_x the regeneration is only incomplete at the point of time t_y. thus only 10% of the accumulated soot particles are burned t the point of time t_y. Like the strong drop-down in the pressure course shows, the difference pressure dp sinks thereby already to approximately half the value that it had before the regeneration, thus shortly before the point of time t_y. Due to this clear reaction of the pressure difference one would expect an extensive regeneration success. The fast advance of the pressure difference at the new loading of the particle filter, which takes place after the point of time t_y, is typical for an incomplete regeneration. The fast advance can also be noted in the advance of the tangent 66. From a comparison of the tangent 66 and 64 it is qualitatively apparent that the incomplete regeneration at the point of time t_y comes along with a higher value of the tangent advance than the more complete regeneration at the point of time t_x.

FIG. 4 clarifies this relation more. Curve 68 shows the relation of initial ascents of the difference pressure dp, thus the value of its time derivative d/dt(dp) shortly after a regeneration over the values of the regeneration success in %, which are illustrated along the x-coordinate. The percentage provides thereby the ratio of burned soot particles compared to accumulated soot particles. The value of 100% corresponds thereby a complete regeneration. At a load with 10 g soot and a combustion of 4 g soot at a regeneration this results for example in a value of 40% for the regeneration success.

Regeneration successes, which are higher than 10%, are shown reproducibly in a monotonously falling course of the curve 68 and allow therefore a quantitative evaluation of the regeneration success already if only one regeneration took place. In particular it can be clearly seen that the time derivative d/dt(dp) has significantly higher values in the case of severe incomplete regenerations than in the case of a complete regeneration.

It has shown that this procedure also allows reliable assessments of the regeneration success at an operation of diesel engines in stationary operation points. A preferred embodiment provides therefore an application of the method or one of its embodiments at a combustion engine, in particular a diesel engine, which is operated in stationary operating points. But the application is not limited to applications with only stationary operating points. Thus a further embodiment provides, that a dimension for the exhaust gas mass flow of the combustion engine is created in non-stationary operated combustion engines and that only such results are used, which have been won at a mostly constant exhaust gas mass flow.

1-7. (canceled)

8. A method of assessing a completeness of a particle filter regeneration, wherein the particle filter is traversed by an exhaust gas of an internal combustion engine, the method comprising:
measuring and evaluating a pressure difference that is generated across the particle filter when a flow passes through the particle filter; and
forming a time derivative of the measured pressure difference, wherein the assessment of the completeness of the particle regeneration proceeds as a function of the time derivative.

9. The method of claim 8, further comprising comparing a time derivative that has been created after an end of the regeneration to a default threshold value, wherein the regeneration is assessed as successful when the time derivative is less than the default threshold value.

10. The method of claim 9, further comprising comparing the time derivative with the default threshold value occurs only within a defined time span after the end of the regeneration.

11. The method of claim 8, further comprising creating a dimension for an exhaust gas mass flow of the combustion engine, wherein results of the assessment of the completeness of the particle regeneration are obtained at a substantially constant exhaust gas mass flow.

12. The method of claim 8, wherein the internal combustion engine is a diesel engine, and further comprising operating the diesel engine at a stationary operating point.

13. A control unit configured to implement a method of assessing a completeness of a particle filter regeneration, wherein the particle filter is traversed by an exhaust gas of an internal combustion engine, the method comprising: measuring and evaluating a pressure difference that is generated across the particle filter when a flow passes through the particle filter; and forming a time derivative of the measured pressure difference, wherein the assessment of the completeness of the particle regeneration proceeds as a function of the time derivative.

14. The control unit of claim 13, wherein the control unit is further configured to implement at least one of the following steps:
comparing a time derivative that has been created after an end of the regeneration to a default threshold value, wherein the regeneration is assessed as successful when the time derivative is less than the default threshold value;
comparing the time derivative with the default threshold value occurs only within a defined time span after the end of the regeneration;
creating a dimension for an exhaust gas mass flow of the combustion engine, wherein results of the assessment of the completeness of the particle regeneration are obtained at a substantially constant exhaust gas mass flow; and
whereinupon the internal combustion engine is a diesel engine, operating the diesel engine at a stationary operating point.
